(19) United States
(12) Patent Application Publication
(10) Pub. No.: US 2006/0179045 A1
(43) Pub. Date: Aug. 10, 2006

(54) Retail store recommendation engine

(76) Inventors: Jim Grinsfelder, St. Paul, MN (US); Paul Leska JR., Inver Grove Heights, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/325,160

(22) Filed: Jan. 4, 2006

Related U.S. Application Data
(60) Provisional application No. 60/641,576, filed on Jan. 5, 2005.

(51) Int. Cl. G06F 17/30

(52) U.S. Cl. 707/3

(57) ABSTRACT

A kiosk is presented that filters user search results into a recommended subset of available products as determined by multiple selection criteria selected by a retailer. Each selection criterion is applied separately to the user search results by first comparing the search results against a threshold value. Those products that meet this threshold value are then filtered against a reference profit margin value, with products having a profit margin less than the reference being filtered from the results. Finally, the results are sorted by a variable associated with the selection criteria, with the top products being returned as a result set for each selection criteria. The result sets from all selection criteria are then merged together into a display of recommended products.

### PRIORITY

This application claims the benefit of U.S. Provisional Patent Application No. 60/641,576, filed Jan. 5, 2005.

### FIELD OF THE INVENTION

The present invention relates generally to in-store kiosks. More particularly, it relates to an in-store kiosk for retail stores that recommends products in inventory based upon criteria selected by the customer and store management.

### BACKGROUND OF THE INVENTION

Numerous retailers have introduced information kiosks into the store environment. In many cases, these kiosks contain product information that is searchable by a customer, allowing the customer to find products available at that retailer that meet the customer's needs. However, these kiosks are poorly suited to situations where user queries return many more products than can be easily displayed at once. For instance, in the wine retail environment, a user may search for white wines from Australia. This search might return a listing of over one hundred wines. Such a large list would be of little help to a customer seeking a recommendation.

### SUMMARY OF THE INVENTION

Information kiosks typically return all products in the database that meet search criteria entered by a customer, even if the number of products is quite large. This information overload is not helpful to the customer. Compounding the problem, such kiosks will present all products in the retailers product list, even if a product is not currently in inventory at that location. The net result is that the customer becomes frustrated with their use of the kiosk, abandoning it possibly permanently in favor of in-store staff.

What is needed is a kiosk that can effectively filter user search results to present only an optimized (or “recommended”) subset of available products, while also ensuring that the result set includes only those items on hand at that retail location. To meet this need, a system and method is provided that automatically filters search results according to rules set by the store management.

The present invention accomplishes this by allowing a retail store to set configuration data for an in-store kiosk. This configuration data includes two or more selection criteria that the store management has decided should be used by the kiosk to select products from a user search result for display on the kiosk. The selection criteria are each applied separately to the original user search result. Each application of the selection criteria involves a comparison of the search results to a threshold value for that selection criteria. Only those products that meet this threshold value remain in the results for that selection criteria.

The kiosk then examines the number of products remaining in the results to see if this number exceeds the number of products (M) to be displayed to the customer. If so, the kiosk will filter the results against a reference profit margin value calculated against either the average or median profit margin of the remaining results, or against the average or median profit margin of all products in the retailer's inventory. Those products that have a profit margin less than the reference profit margin are then filtered from the results.

Those results remaining after profit margin prefiltering are then sorted by a variable associated with the selection criteria. The top M products are then returned as a result set for this particular selection criteria.

The result sets from all selection criteria chosen by the retailer are then merged together. The goal of this merger is to select the highest ranked items (according to the selection criteria sort value) from each result set to form a final list of M products for display to the end user.

### BRIEF DESCRIPTION OF THE DRAWINGS

FIG. 1 is a schematic diagram showing the various physical elements used in the present invention.

FIG. 2 is a chart showing a representation of the end user presentation layout.

FIG. 3 is a diagram showing parameters that can be chosen by a retailer to configure its system.

FIG. 4 is a flowchart showing a recommendation algorithm of the present invention.

FIG. 5 is a flowchart showing the general retailer's criterion selection algorithm of the present invention.

FIG. 6 is a flowchart showing a retailer's criterion selection algorithm for the average profit margin method for the profit margin prefiltering criterion

FIG. 7 is a flowchart showing a retailer's criterion selection algorithm for the median profit margin method for the profit margin prefiltering criterion

FIG. 8 is a flowchart showing an algorithm for merging the results of multiple criterion selection algorithms.

FIG. 9 is a flowchart showing an algorithm for presenting recommendations to an end user.

### DETAILED DESCRIPTION OF THE INVENTION

Overview of the System

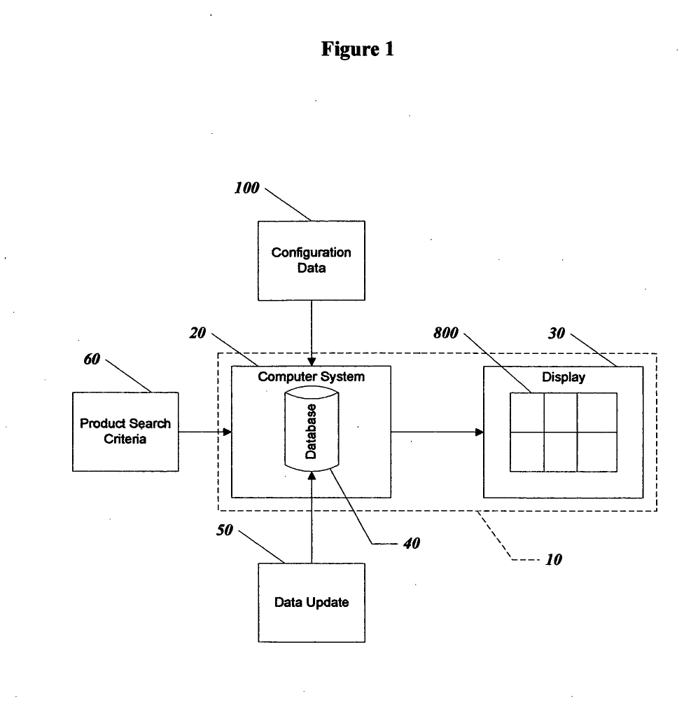

FIG. 1 shows the major components and data inputs of a kiosk 10 of the present invention. The kiosk 10 is primarily composed of a computer system 20 and a display 30. The computer system 20 is preferably a general purpose computing system, such as those operating Microsoft Windows, Apple Mac-OS, or Unix-based operating systems. As such, the computer system 20 is generally microprocessor based, utilizing a microprocessor manufactured by Intel, Motorola, Sun, IBM, or similar manufacturer.

The computer system 20 contains a database system 40, which includes data structures and computer software to manage a large amount of data. The database system 40 contains characteristics and inventory levels for products at a retail store. The database system 40 may be a general purpose database system, or may be a specially designed wine categorization database system such as that proposed in U.S. Provisional Application No. 60/641,573, filed by the inventors of the present application on Jan. 5, 2005, and which is hereby incorporated by reference. In the preferred embodiment, database system 40 can be updated automatically through an external database update component 50. This component 50 may include a local point of sale system that automatically tracks inventory, or may be a central inventory management system that manages all data in a multi-store retail environment. The update component 50 ensures that the data in database 40 is regularly updated to contain data relating to products actually in inventory in a retail environment.

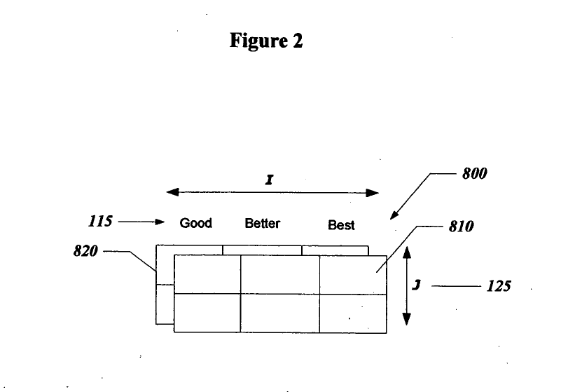

The purpose of the kiosk 10 is to recommend products to a customer based on a combination of a product search criteria 60 specified by a customer and configuration data 100 specified by the retailer. This input can be provided to the computer system 20 through any traditional input mechanism such as a keyboard, a touch-sensitive screen, or, in the case of configuration data 100, by a configuration file previously established by the retailer. Ultimately, product recommendations are displayed by the kiosk 10 to the customer on display 30. In the preferred embodiment, this recommendation is provided in the form of a recommendation table 800, as shown in FIG. 2 and as described in more detail below.

Potential users of the system are not limited to customers, but include, for example, employees of the retail store, management from a parent company of the retailer, or representatives from companies within the retailer's supply chain. Reference herein to “customer(s),” the most important users, should not be construed to be exclusionary of other potential classes of users.

Configuration Data

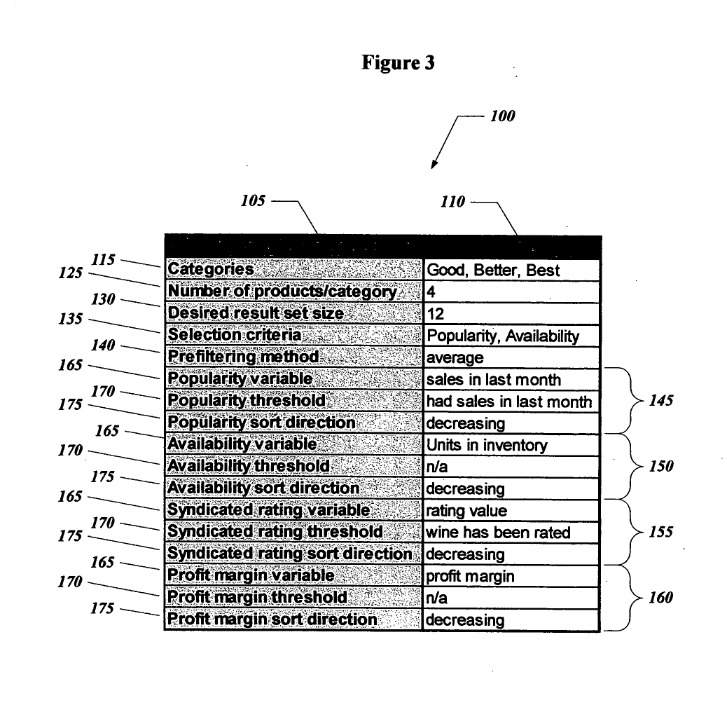

The configuration data 100 used by the retailer to configure the kiosk 10 and control the recommendations 800 for a given search criterion 60 is shown in more detail in FIG. 3. It is important to allow retailers to define their own configuration data 100 because each retailer will have a separate goal in mind for their kiosks 10. By creating a easy technique to customize the functionality of the kiosk 10, a single kiosk design can be implemented in a variety of retail settings while still being fully customizable by each retailer.

The configuration data 100 is used to prioritize and filter the potentially large set of products returned by a customer's search criteria. FIG. 3 shows the configuration data 100 as a table of typical parameters 105 and assigned values 110. Configuration data 100 must be received by the kiosk 10 at least once to initialize the computer system 20. After the initial configuration, the configuration parameters 105 may be left unchanged or may be revised from time to time as desired by the retailer.

The first listed parameter 105 is categories 115, which indicates the categories in which the recommended products will be grouped for display to the customer. The categories 115 form the columns in the recommendation table 800. The retail organization can indicate a particular number of categories, such as the three categories good, better, best shown in FIGS. 2 and 3. This number is symbolized as the letter I in this application, as seen in the detail of the recommendation table 800 shown in FIG. 2. Categories 115 are primarily used to help the customer determine which products to purchase. Products in the higher categories 115 (to the right side of FIG. 2) are generally of better quality but are usually more expensive.

The second parameter 105 is the number of products per category 125, which indicates the number of products that will be displayed for each category 115. This number is indicated as the letter J in FIG. 2, and allows the kiosk 10 to give the customer more than one option per category 115 by presenting multiple rows of products in the recommendation table 800. The number of categories 115 and the number of products per category 125 govern the total number of products (M) that the kiosk 10 will display to the customer in the recommendation 800. This number M (I×J) may also be chosen directly by the retailer as parameter 130, in which case the retailer would usually chose an integer multiple of the number of categories 115 (I). In most embodiments, the retailer will chose either the number of products per category 125 or the desired result set size 130, but not both.

The selection criteria 135 is one of the most important parameters 105 established by the retailer, as the kiosk 10 uses the selection criteria 135 to filter the products returned by the customer's search criteria 60. The selection criteria 135 contains a list of characteristics for the products being sold by a retailer. In the context of a wine retail environment, the selection criteria might include the popularity of the wine 145, the availability of the wine 150, the syndicated rating of the wine 155, and the profit margin of the wine 160. These example selection criteria 135 are shown in FIG. 3a.

The popularity criterion 145 is indicative of the number of units of a product sold within a given timeframe. By selecting this criterion 135, the retailer will cause the recommendations 800 to more frequently includes wines that have previously been popular with the retailer's customers. In this way, it is likely that this selection criterion 145 will help keep the recommendation of the kiosk 10 consistent with past recommendations made by store employees and past desires of customers.

The availability criterion 150 is the number of units of a product within the retailer's inventory. Depending upon the embodiment, this might also take into account merchandise that is on order, in warehouses, or located in establishments of affiliated parties (e.g., a parent corporation, or other franchise stores). Using this selection criterion 135 means that, when all other factors are equal, the kiosk 10 is more likely to recommend products that have a high availability. This means that the recommendation of the kiosk will be correlated with the recent purchasing decisions made by the retailer management.

The syndicated rating criterion 155 correlates with the ratings made by experts of the product. Using this selection criterion 135 allows the kiosk 10 to make recommendations that correlate with the recommendations made by experts.

Finally, the profit margin criterion 160 analyzes the percentage profit margin (price minus cost, divided by price). This criterion allows the recommendation kiosk 10 to include in its recommendations those products that bring the highest profit margin to the retailer.

In the preferred embodiment, the retailer need not select all of these criteria 135, but rather selects those criteria of most interest to the retailer. In the chart shown in FIG. 3, the retailer has chosen to select the products based on the popularity 145 and availability 150 of the products. When the retailer selects a particular criterion 135, the kiosk 10 has at is disposal four parameters related to the selected criterion 135: a criterion variable 165, a criterion threshold 170, a criterion sort direction 175, and a profit margin pre-filter indicator 180. These parameters can be permanently and unalterably associated with the selection criteria 135 available for selection by the retailer, although it is possible to create the kiosk 10 such that these parameters form part of the configuration data 100 directly chosen by the retailer.

The criterion variable 165 indicates the actual variable that must be sorted for the purpose of prioritization. For example, the criterion variable 165 for popularity criterion 145 is number of units sold within some recent time frame, such as the month prior to the customer's query.

The criterion threshold 170 is a threshold value under which a product should be immediately eliminated from the selection process. For example, for popularity criterion 145, the threshold 170 shown in FIG. 3 is whether the product had any sales within the month prior to the customer's query. For some criteria 135, specifying a threshold 170 would be meaningless or superfluous. For example, in the present invention the customer's search 10 is guaranteed to return only products that exist in inventory; thus, the availability 150 selection criterion 135 does not need to verify for a second time that the product is in inventory. However, if so desired, the retailer may require that at least two items be in stock before a recommendation be made. In this case, the present invention could create an availability threshold 170 of two items in inventory.

The sort direction 175 indicates whether values associated with the selection criteria 135 should be sorted in increasing or decreasing order. This sort direction 175 should to ensure that the most desirable products according to that criterion 135 appear first. Products with high syndicated ratings 155, for example, are more desirable, so the sort order for that criterion 135 should be decreasing. Coincidentally, all the criteria 135 shown in the table relevant to wine sales require decreasing order. But if the product were laptop computers and the criterion 135 were weight, then smaller numbers would be better and the sort would need to be done in ascending order.

The profit margin prefilter indicator 180 indicates whether the kiosk should filter the products found by the user's search criteria 60 by the profit margin. In the example shown in FIGS. 3 and 3a, all selection criterion 135 prefilter by profit margin except the profit margin criterion 160.

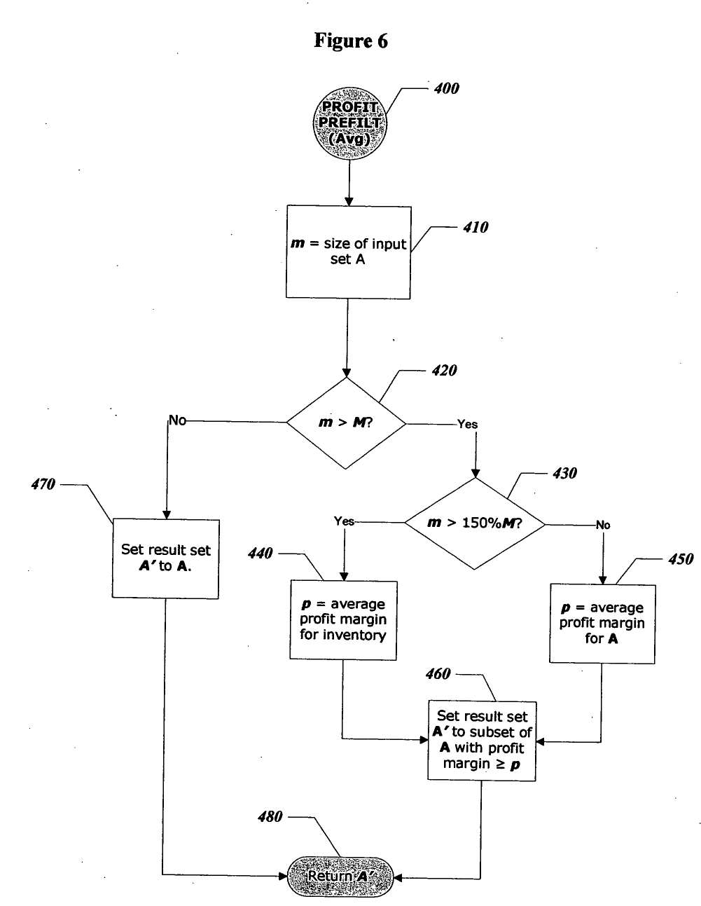

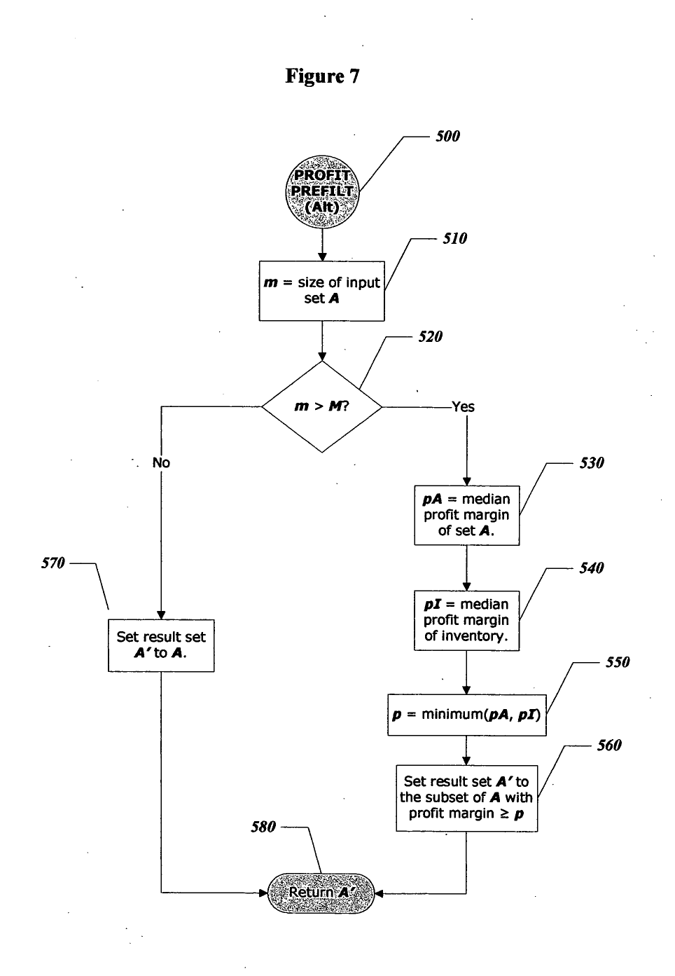

The final configuration parameter 105 in configuration data 100 is the profit margin prefiltering method 140. Each of the selection criteria 135 is applied to the set of products produced by the customer's search criteria 60 sequentially. As one of the steps in processing a given selection criterion 135, prefiltering to focus the selection on products with higher profit margin may optionally be performed. Such prefiltering would be redundant, however, when the selection criterion 135 is itself profit margin 160, and is not done. One way of implementing the prefiltering of the present invention is to define multiple methods of prefiltering, and to allow the retailer to select between the alternative algorithms. The table in FIG. 3 allows only a single value of prefiltering method 140 to be selected and applied to all selection criteria 135 (except, as already discussed, profit margin 160), but in an alternate embodiment, each selection criterion 135 could be independently configured for the prefiltering that should be performed for that criterion 135. FIG. 3 shows the selected prefiltering method as “average,” which is shown in FIG. 6. An alternative method is discussed in connection with FIG. 7. While these two methods are preferred, other methods are within the scope of the present invention.

Overall Method

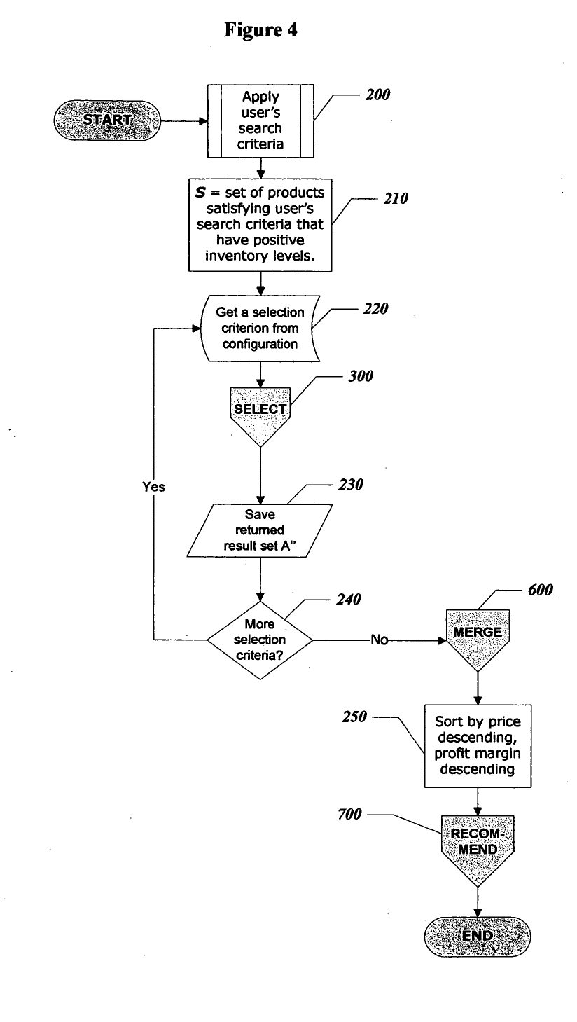

FIG. 4 shows an algorithm for generating a recommended subset of products based on combining the result of a search based on search criteria 60 chosen by the customer with two or more selection criteria 135 specified by the retailer in the configuration data 100. The process begins by applying the customer's search criteria 60 at step 200. The customer searches the total database 40 of products by selecting zero or more attributes values. In a wine retail context, examples of possible attributes are the wine varietal (e.g., Zinfandel) and the region where the wine was produced (e.g., California). The result is a subset S, which is defined at step 210 to be the set of products that satisfy the user's selection criteria and are actually available for sale in the retailer's inventory (or perhaps otherwise available).

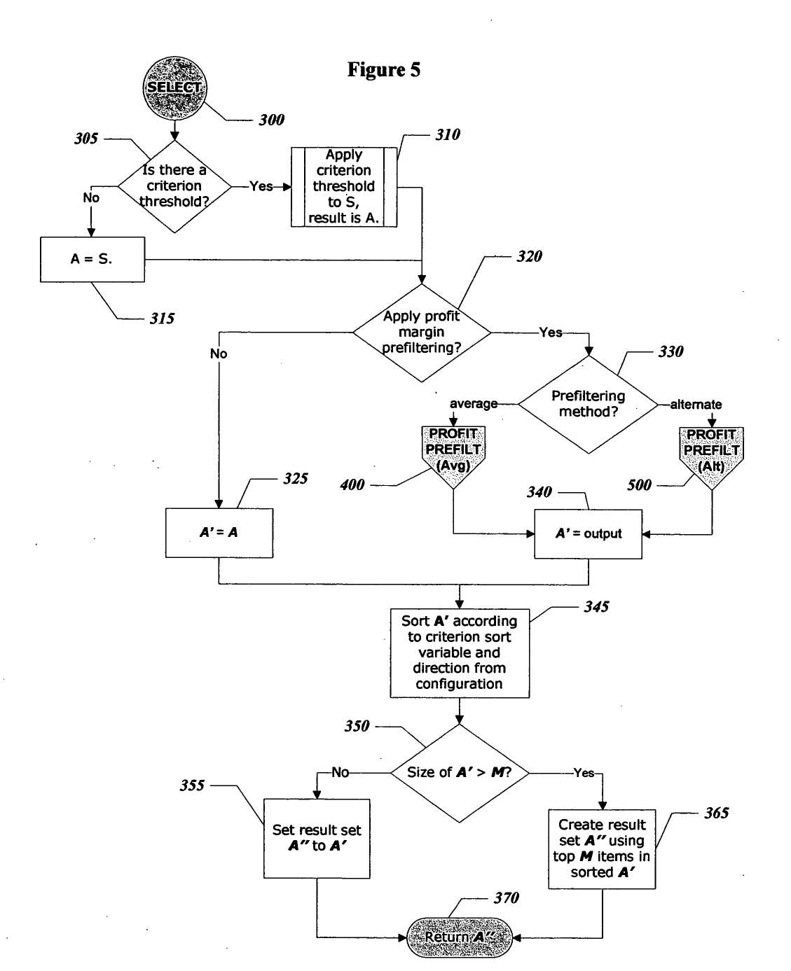

The loop between steps 220 and 240 filters the set S of products chosen by the customer by sequentially applying the retailer's selection criteria 135 specified in the system configuration 100. Step 220 chooses a single selection criterion from the multiple criteria 135 selected by the retailer. The details of applying the chosen criterion, labeled “SELECT” 300, are illustrated in FIG. 5. The selection step 300 always starts fresh with the set S when a new criterion 135 is processed. The subset of S resulting from selection based on a given criterion 135 (A″) is saved at step 230 for subsequent merger with the corresponding subsets produced from any other criteria 135. Step 240 determines if any more selection critieria 135 were established by the retailer. If so, the next selection is taken at step 220 and SELECT step 300 is executed on the next criteria 135.

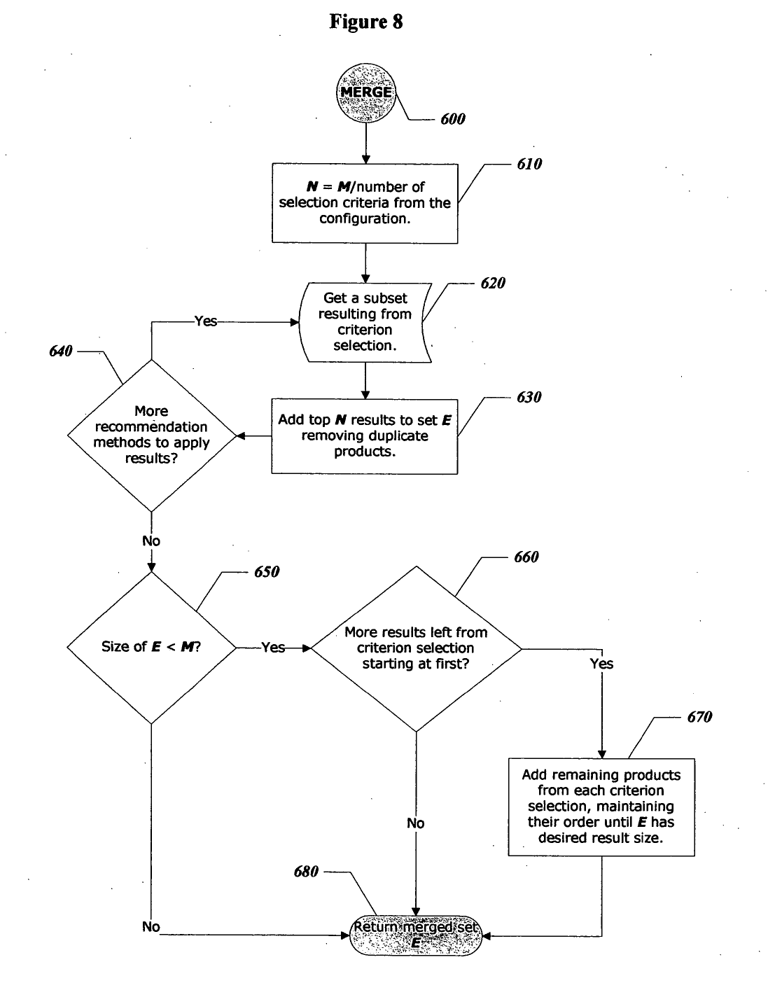

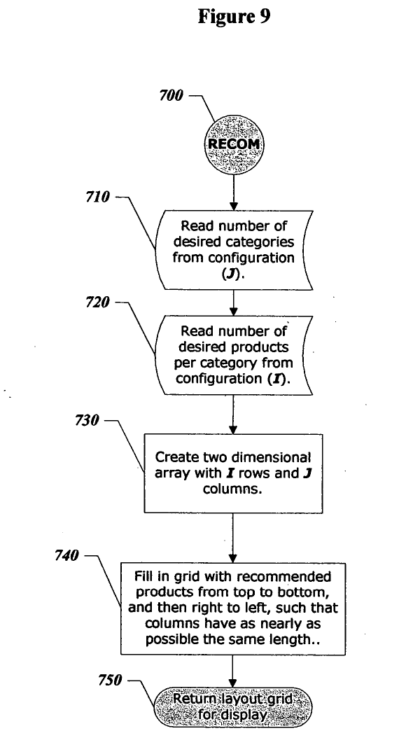

If not, the “MERGE” step 600, which is detailed in FIG. 8, is executed. This step 600 merges the various subsets saved at step 230. The final product list created by the MERGE step 600 is sorted at step 250. In the preferred embodiment, this sorting is made first by descending price and second, for results with the same price, by profit margin descending. A recommendation 800 is then prepared for the user in step “RECOM” 700, as detailed in FIG. 9. In this step 700, the sorted results are laid out into a grid 800 that is optimized for profit margin and in which the quality of the recommendation improves moving from left to right in the grid 800. The grid 800 of results is presented to the customer as a recommended subset of the products they selected based on their search criteria 60.

Selection of Products by a Retailer's Criterion

The algorithm in FIG. 5, which expands the step labeled “SELECT” 300 from the flowchart of FIG. 4, is applied for each one of the retailer's selection criteria 135. If step 305 finds that the system configuration 100 so specifies, a filter based upon the retailer specified threshold value 170 is applied at 310 to obtain a subset A of S. Otherwise, as shown at step 315, A is simply set to S. This step 310 ensures, for example, that items to be selected based on expert ratings 155 are pre-filtered to remove those items that have not been rated by an expert.

Next, at step 320, the algorithm determines from the configuration 100 whether profit margin prefiltering is to be applied for the current selection criterion 135 by examining column 180. If the selection criterion 135 being processed is itself profit margin 160, then such prefiltering would be redundant and is omitted. If prefiltering is required by the configuration 100, then the method of prefiltering is determined at step 330. This is determined by analyzing the prefiltering method 140 selected in the configuration data 100. In the described embodiment, two prefiltering embodiments are provided, an “average” profit margin algorithm (labeled “PROFIT PREFILT (Avg)” 400, detailed in FIG. 6), and an alternate algorithm (labeled “PROFIT PREFILT (Alt)” 500, detailed in FIG. 7). If prefiltering of either flavor has been performed, then the output subset of products is called A′ as indicated as step 340. Otherwise, A′ is set at step 325 to A.

The set A′ is sorted at step 345 by the criterion variable 165 in the sort direction 175 specified in the configuration data 100. If step 350 then determines the set A′ is larger than M (the desired result set size 130 from the retailer's configuration 100), then the subset to be returned by the select algorithm 300 (A″) is set 365 to the top M products taken from the sorted list. Otherwise, the result subset A″ is set at step 355 to A′. Finally, A″ is returned at step 370 as the result subset from selection algorithm 300 for the processed criterion 135.

Average Profit Margin Pre-Filtering

FIG. 6 shows the algorithm for average profit margin prefiltering, expanding step “PROFIT PREFILT (Avg)” 400 of FIG. 5. The purpose of profit margin prefiltering, by either by this method, which is the preferred embodiment, or by the alternate one shown in FIG. 7, is to choose more profitable products from the list returned by the customer's search criteria 60 in the event that the list is large.

At step 410, m is defined to be the size of the set (A) input to the algorithm 400. If step 420 determines that m does not exceed M (the number of displayed products in recommendation table 800), then the algorithm's result set A′ is set at step 470 to A. Otherwise, step 430 determines whether m exceeds some larger number (150% of M in the preferred embodiment) or not. This determination 430 decides whether a variable (p) is set to the average profit margin from the retailer's whole inventory in database 40 at step 440, or whether p is set to the average profit margin from the input set A at step 450. In either case, the result set A′ is set at step 460 to the subset of the input set A whose profit margins exceed p. The result set A′ is then returned 480. The purpose of step 430 is to avoid the use of the profit margin for the whole inventory (used in step 440) in some instances. This is required to prevent undue filtering of the search results A. If this were not done, a small result set (say 8 wines when a total of 6 recommendations are to be expected) may contain a majority of wines of lower than average profitability (say 7 of the 8 wines). If these wines were to be compared to the average profitability of the entire database 40, then the result set A′ would be very small (one product), and the influence of this selection criteria 135 on the final recommendations would be significantly reduced. The use of step 450 to determine p would reduce this problem. Of course, the median profitability could be used instead of the average profitability in both steps 440 and 450.

FIG. 7 shows an alternate embodiment of profit margin prefiltering (expanding the step labeled “PROFIT PREFILT (Alt)” 500 in FIG. 5). This algorithm 500 compares the size of the set A input to the algorithm to M, the desired result set size 130 (steps 510 and 520). For the case of m>M, in steps 530-560, we simply set p to the smaller of the median profit margin for the retailer's inventory and the median profit margin for the input set A, and then retain as A′ the subset of the input having profit margin exceeding p. If m<M, we set A′ to A. The resulting subset A′ is returned at step 580.

Merging Recommendation Lists

After results are returned from two or more of the various subset selection methods through the SELECT algorithm 300, they need to be saved in step 300 and combined in the MERGE algorithm 600 as shown in FIG. 8. In performing this merger, each result set A″ maintains its sort order so the best results are returned in the merged list.

The number of results N that should be contributed from each result set A″ is calculated at step 610 by dividing the desired result set size (M) by the number of selection criteria 135 methods applied. In the preferred embodiment, M will be evenly divisible by the number of subset selection 300 methods, but this is not a requirement of the present invention. In step 620, a result set A″ for a selection criterion is obtained. The top N results from the obtained subset selection 300 are added in step 630 to a new subset called E. Step 640 cycles through all of the selection criteria 135 and repeats step 620 and 630 for each. In each case, E accumulates 630 the top results from each of the other selection criteria 135.

It is possible that a subset A″ from a selection criterion 135 will have fewer than N members. This can happen when step 310 of FIG. 5, step 460 of FIG. 6, or step 560 of FIG. 7 reduces the size of the returned subset A″ for a given selection criterion. In this case, all members of the subset A″ are added to E in step 630.

It is also likely that, in the second and any subsequent selection criteria 135, the addition of items to set E in step 630 will cause duplications in E. Step 630 therefore checks for duplications, and either avoids adding duplicates or deletes them after they are added. When a duplicate is detected, step 630 may simply place an additional item into set E from the current subset A″ that contained the duplicate entry. Alternatively, the gaps created in E by deleting the duplicate entries can be filled in steps 650-670 as described below.

Once results from each criterion 135 have been added to E, then the size of E is compared in step 650 to M, the desired result set size 130. If set E is smaller than M then step 660 determines whether there are more results in any of the relevant subsets A″ that are not in E. If more results exist, they are added 670 to E going from recommendation subset A″ from the first selection criterion 135 to the last until the subset E has the desired size. This can be accomplished either by alternatively taking one item at a time from each recommendation subset A″, or by exhausting all of the first, then all of the second, and so forth. The merged results are then returned in step 680 in a subset E that will contain M or fewer entries.

Laying Out Recommendation Results into a Grid

As shown in FIG. 4, subset E returned at step 680 is sorted by price and profit margin at step 250 and then presented to the user through “RECOMMEND” algorithm 700. FIG. 9 illustrates how this algorithm 700 creates the final layout of the merged recommendation results in the form of recommendation grid 800. The process 700 begins by obtaining in steps 710 and 720 the number of categories 120 (denoted by J) and the number of products per category 125 (denoted by I) from the configuration data 100. As discussed earlier, M, the desired result set size 130, is the product of J and I.

A two dimensional table or array is created at step 730 having I rows and J columns. The recommended products are filled at step 740 into the grid 800 starting at the upper right hand corner 810. If the total number of entries in E is equal to M, the table 800 is filled from top to bottom, and from right to left, starting in the upper right hand corner 810, as shown in the following table.

| | | |
|---|---|---|
| 5 | 3 | 1 |
| 6 | 4 | 2 |

If E contains fewer than M products, but more than I, then the table 800 is filled in the same way as if E equals M, as shown in this table.

| | | |
|---|---|---|
| 5 | 3 | 1 |
| | 4 | 2 |

Finally, if E contains I or fewer products, then the table is filled from right to left, starting in the upper right hand corner 810:

| | | |
|---|---|---|
| 3 | 2 | 1 |

FIG. 2 shows that it is possible to define grid 800 to contain a second page 820 that is not shown unless required. In this way, an initial page of grid 800 is shown to the user, with the ability to show one or more additional pages 820 of recommendations. If multiple pages are required in grid 800, then the tables should be filled starting at the upper right hand corner 810 of the first page, going down to fill the right hand most column, and then filling the right hand most column on the second and all other pages before returning to the first page to fill the second right-hand-most column from top to bottom. This is seen in the following tables:

| | | |
|---|---|---|
| 9 | 5 | 1 |
| 10 | 6 | 2 |
| 11 | 7 | 3 |
| | 8 | 4 |

### EXAMPLE

The functionality of the different algorithms used by the present invention is best understood by working through an example. In this illustration, a user may search for all California Zinfandels in inventory at a retail wine store. This search result returns 200 different vintages. The retailer wishes to use the present invention to automatically recommend of a limited subset (say 6) of these 200 vintages. Using the configuration data 100, the retailer has requested that the recommendations produced by the present invention kiosk 10 be based upon expert ratings 155 and availability in the store 150. The present invention applies the algorithm of FIG. 4 to the 200 items in the search results “S.” Since the retailer has selected two criteria 135, the Select 300 algorithm will apply the algorithm of FIG. 5 on each of these selection criteria 135. The results will then be merged together using the merge algorithm 600 of FIG. 8, with the remaining 6 vintages then being presented to the use at step 700.

The expert rating selection criteria chosen by the retailer requires at step 305 and 310 in FIG. 5 that the 200 vintages found by the user search criteria 60 be filtered to include only those vintages that have received an expert rating (say 100 in total). If there were no prefiltering based on profit margin, these 100 vintages would be sorted by expert rating in descending order in a first result set A″. Next, the availability selection criterion is applied. Assuming that there is no criterion threshold, all 200 wines will remain in the result set A″ from this selection criteria, which would be sorted by availability. When these results are merged in step 600, the top three wines in each result set A″ are combined into a single set, which is then sorted by price and displayed.

To improve the profit margin on items selected by the kiosk 10, the retailer may have elected to use one of the profit margin prefiltering techniques 400, 500. These techniques are implemented only when the result sets are appropriately large, as controlled by steps 420 and 520 of FIGS. 6 and 7, respectively. Both prefiltering techniques 400, 500 attempt to ensure that the wines recommended by the kiosk are sold for a price giving the retailer an at least average or median profit margin. By ensuring that the filters apply only when the result set is significantly large, these prefiltering techniques avoid undue influence over the results. In the above example, the two result sets A″ would contain approximately 50 of the most profitable wines in the user search results sorted by expert rating, and approximately 100 of the most profitable wines in the user search results sorted by availability. The top three results from each list (sorted by rating and availability) will then be merged together and sorted by price for display to the user. To allow profit margin to have a greater influence over the results returned by the kiosk 10, the retailer need only specify profit margin 160 as one of the desired selection criteria 135.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of recommending a set of products, comprising:
a) receiving product search criteria from a customer at a computerized kiosk containing a computer system and display;
b) retrieving search results at the computer system by applying the search criteria against a database of products in inventory at a retail location;
c) applying a plurality of retailer selection criteria to the search results, each retailer selection criteria having a criterion variable and a sort direction, with each retailer selection criteria creating a result subset of the search results sorted against the criterion variable according to the sort direction;
d) merging the plurality of result subsets into a single display set of products; and
e) displaying the display set of products to the customer.

2. The method of claim 1, wherein at least one of the retailer selection criteria further has a threshold value, wherein the threshold value is used to filter products from the result subset wherein the filtered products have a characteristic that does not meet the value of the threshold value.

3. The method of claim 2, wherein at least one retailer selection criteria is associated with a profit margin filter, wherein the products in the search results each have a profit margin value, and further wherein the profit margin filter removes those products from the result subset that have a profit margin value below a reference profit margin value.

4. The method of claim 3, wherein the reference profit margin value is chosen from the set comprising the average profit margin of the search results, the median profit margin of the search results, the average profit margin of the products in inventory, and the median profit margin of the products in inventory.

5. The method of claim 4, wherein the reference profit margin is selected based upon the number of products remaining after the threshold value is used to filter products from the result subset.

6. The method of claim 5,
wherein the reference profit margin is set to zero or not used if a remaining products number, being the number of products remaining after use of the thresehold value, is below a display number, being the desired number of products to be displayed to the customer;
wherein the reference profit margin is set to the average profit margin of the search results if the remaining products number exceeds the display number but is less than the display number times a preset multiplier; and
wherein the reference profit margin is set to the average profit margin of the product in inventory if the remaining products number exceeds the display number times the preset multiplier.

7. The method of claim 6, wherein the preset multiplier is 1.5.

8. The method of claim 1, wherein at least one retailer selection criteria is associated with a profit margin filter, wherein the products in the search results each have a profit margin value, and further wherein the profit margin filter removes those products from the result subset that have a profit margin value below a reference profit margin value.

9. The method of claim 1, wherein the process of merging the plurality of result subsets is accomplished by selecting an approximately equal portion of products from each result subset, the selected portions containing the highest ranked products from each subset according to the criterion variable and sort direction.

10. A method of recommending a set of products in a computerized retail store kiosk, comprising:
a) establishing a desired display set size M;
b) applying customer search criteria to a set of data stored in a computerized database relating to in store inventory to obtain a set of qualifying products S;
c) applying a first retailer selection criterion to S through a computerized subsetting process to obtain a first ranked result subset;
d) applying a second retailer selection criterion to S through the computerized subsetting process to obtain a second ranked result subset; and
e) applying a computerized merger process to the first ranked subset and the second ranked subset to produce a display set having no more results than M.

11. The method of claim 10, wherein the subsetting process comprises eliminating those products having a profit margin less than an average profit margin value for the products in a retailer inventory, and then ranking the remaining products according to the retailer selection criterion being applied to create a ranked result subset.

12. The method of claim 10, wherein the subsetting process comprises eliminating those products having a profit margin less than the average profit margin value for the products in S, and then ranking the remaining products according to the retailer selection criterion being applied to create a ranked result subset.

13. The method of claim 10, wherein the subsetting process comprises eliminating those products having a profit margin less than the smaller of the median profit margin value for the products in a retailer inventory and the median profit margin value for the products in S, then ranking the remaining products according to the retailer selection criterion being applied to create a ranked result subset.

14. The method claim 10, wherein the merging process comprises:
i) Setting a number N equal to M divided by the number of retailer selection criteria being applied; and
ii) Combining the N most highly ranked items from each of the ranked result subsets into the display set.

15. The method of claim 10, wherein the set of products contains wine products and the first retailer selection criterion and the second retailer selection criterion are members of the group consisting of availability in inventory, popularity with consumers, profit margin, and syndicated rating.

16. A retail store kiosk for recommending products in inventory at the retail store comprising:
a) a computer system containing a microprocessor and a database, the database containing records relating to the products in inventory;
b) a display for presenting product information to a customer;
c) a search input for receiving search criteria from the customer;
d) a configuration input for receiving configuration data, the configuration data containing a plurality of selection criteria, each selection criteria being associated with a criterion variable and a sort direction;
e) a search algorithm that applies the search criteria to the database to create a search result set;
f) a selection criteria algorithm that applies a selected selection criterion against the search result set to create a result subset of the search results sorted against the criterion variable and the sort direction associated with the selected selection criterion; and
g) a merge algorithm that merges the result set for each of the plurality of selection criteria into a single display set of products for presentation to the customer on the display.

17. The kiosk of claim 16, wherein at least one of the selection criteria is associated with a threshold value, wherein the threshold value is used by the selection criteria algorithm to filter products from the result subset wherein the filtered products have a characteristic that does not meet the value of the threshold value.

18. The kiosk of claim 17, wherein at least one selection criteria is associated with a profit margin filter, wherein the products in the search results each have a profit margin value, and further wherein selection criteria algorithm uses the profit margin filter to remove those products from the result subset that have a profit margin value below a reference profit margin value.

19. The kiosk of claim 18, wherein the reference profit margin value is chosen from the set comprising the average profit margin of the search results, the median profit margin of the search results, the average profit margin of the products in inventory, and the median profit margin of the products in inventory.

20. The kiosk of claim 16, wherein at least one selection criteria is associated with a profit margin filter, wherein the products in the search results each have a profit margin value, and further wherein selection criteria algorithm uses the profit margin filter to remove those products from the result subset that have a profit margin value below a reference profit margin value.
